(19) United States
(12) Patent Application Publication
(10) Pub. No.: US 2003/0025051 A1
(43) Pub. Date: Feb. 6, 2003

(54) Self adjusting furniture foot assembly

(76) Inventor: Ian Andrew MacDonald, Belcarra (CA)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 09/921,385

(22) Filed: Aug. 2, 2001

(51) Int. Cl. F16M 11/24

(52) U.S. Cl. 248/188.4

(57) ABSTRACT

A self-adjusting furniture foot assembly has an upper member slidably engaged with a lower member. Between the upper and lower members, a biasing member urges the two apart while a dampening member resists acceleration of the second member toward the first member. Consequently, the foot assembly can slowly compensate to an uneven support surface for an item of furniture, and can quickly reset itself when the furniture is lifted.

### BACKGROUND OF THE INVENTION

1. Field of the Invention

The present invention relates to apparatus and methods for supporting furniture. More particularly, the present invention relates to apparatus and methods for supporting furniture on uneven surfaces to automatically stabilizes the furniture to prevent it from rocking.

2. Description of the Related Art

There are few if any people who have not, at one time or another, sat at a table that was not squarely supported on the ground. When, for example, the ground below a table is uneven, the legs of the table do not all touch the ground at the same time. As a result, the table will rock back and forth. If such a table is in a restaurant, such a rocking motion can result in spilled food or drinks, causing patrons to be annoyed or upset and causing waiters to make unnecessary, repeated trips to and from the table to replace spilled items. Each of these situations can result in a bad experience for the patron, a bad tip for the waiter, or a bad reputation for the establishment.

A wide variety of articles, such as matchbooks, playing cards, and pieces of wood, have been used to shim the short leg of a table to compensate for an uneven surface. Invariably, such solutions are temporary at best. Similarly, tables have been manufactured with threaded feet to be adjustable for compensating for an uneven surface. The adjustment that is suitable for one position, however, may not be suitable for another, ultimately resulting in the table again rocking. Although many attempts have been made, there is yet to be a widely accepted solution to this age-old problem.

Similarly, most every type of furniture, such as chairs and benches, also have such a problem when used on uneven surfaces. Thus, there is a need for adjustable furniture feet that not only adjust for uneven surfaces, but that also will readjust as the furniture is moved.

### BRIEF SUMMARY OF THE INVENTION

The present invention is directed toward items of furniture with feet assemblies that automatically adjust to uneven surfaces, toward foot assemblies that can be attached to furniture for such a purpose, and toward a method for adjusting furniture to compensate for uneven surfaces. One embodiment of the present invention incorporates a first foot member, a second foot member, a biasing member and a dampening member. The first foot member is coupled to a lower portion of a piece of furniture, such as the bottom of a leg. The second foot member is slidably coupled to the first foot member to reciprocate with respect to the first foot member along an axis that, during use, intersects the surface supporting the furniture, such as a floor. The biasing member is positioned between the first and second foot members to urge them apart from each other. The dampening member is also coupled between the first and second foot members, and contains a flowable liquid that is forced through a restricted opening when the second foot member moves toward the first foot member. As a result, acceleration of the second foot member toward the first foot member is dampened.

During use, the biasing member urges the second foot member apart from the first foot member until the furniture is set on the supporting surface. If one of the second foot members does not contact the supporting surface after the furniture is set down, the weight of the furniture will force the adjacent foot members to collapse against the force of the biasing member and the resistance of the dampener, until the elevated foot member contacts the supporting surface. As a result, shortly after the furniture is repositioned on the uneven surface, the furniture will settle until it is stabilized.

In another embodiment, dampening member of the adjustable foot assembly comprises a cavity having first and second chambers divided by a dividing member with an aperture therein. As the second foot member moves toward the first foot member, fluid in one of the two chambers is forced through the aperture into the other chamber. The size and shape of the aperture can be selected to create a desired rate of movement.

In still another embodiment of the present invention, one chamber of a dual-chambered cavity is made from a rigid material while the other chamber is made from a resilient material. As the second foot member moves toward the first foot member, the resilient material of the second chamber is deformed, forcing the fluid through the aperture and into the first chamber.

In still another embodiment of the present invention, a valving means is positioned with the aperture between the first and second chambers. The valving means is movable between an open position in which the fluid is relatively free to flow between the first and second chambers, and a closed position in which the fluid is substantially restricted between the first and second chambers. As the second foot member moves toward the first food member, an increased pressure in the fluid moves the valving means from the open position to the closed position. Further movement of the second foot member toward the first foot member is dampened because the valve is in the closed position. If the furniture were lifted, however, the force urging the second foot member toward the first foot member would be removed, resulting in a pressure decrease in the resilient chamber. When the pressure in the resilient cavity decreased below a pre-determined threshold, the valving means moves from the closed position back to the open position, allowing the foot assembly to return to its default configuration at an increased rate.

In still further another embodiment, a biasing means is positioned between the wall of the resilient chamber and the valving means. The biasing member increases the force on the valving means, resulting in an increased dampening effect.

The present invention is also directed toward furniture that is configured with such foot assemblies, and to methods of adjusting furniture to compensate for uneven surfaces.

### BRIEF DESCRIPTION OF THE SEVERAL VIEWS OF THE DRAWINGS

FIG. 1 is an isometric view of a portion of an item of furniture and a self-adjusting foot assembly according to one embodiment of the present invention.

FIG. 2 is an exploded view of the foot assembly of FIG. 1.

FIG. 3 is a plan view of a lower cup member of the foot assembly of FIG. 2.

FIG. 4 is a sectional elevation view of the lower cup member of FIG. 3, viewed along Section 4-4.

FIG. 5 is a plan view of a ferrule of the foot assembly of FIG. 2.

FIG. 6 is a sectional elevation view of the ferrule of FIG. 5, viewed along Section 5-5.

FIG. 7 is a diametric sectional view of a diaphragm member of the foot assembly of FIG. 2.

FIG. 8 is a plan view of a button valve of the foot assembly of FIG. 2.

FIG. 9 is a sectional elevation view of the button valve of FIG. 8, viewed along Section 9-9.

FIG. 10 is a plan view of a washer of the foot assembly of FIG. 2.

FIG. 11 is a sectional elevation view of the washer of FIG. 10, viewed along Section 11-11.

FIG. 12 is a plan view of an upper cup member from the foot assembly of FIG. 2.

FIG. 13 is a sectional elevation view of the upper cup member of FIG. 12, viewed along Section 13-13.

FIG. 14 is a sectional elevation view of the foot assembly of FIG. 1 in an extended configuration, as viewed along a diametric section.

FIG. 15 is a sectional elevation view of the foot assembly of FIG. 14 in a compressed configuration.

### DETAILED DESCRIPTION OF THE INVENTION

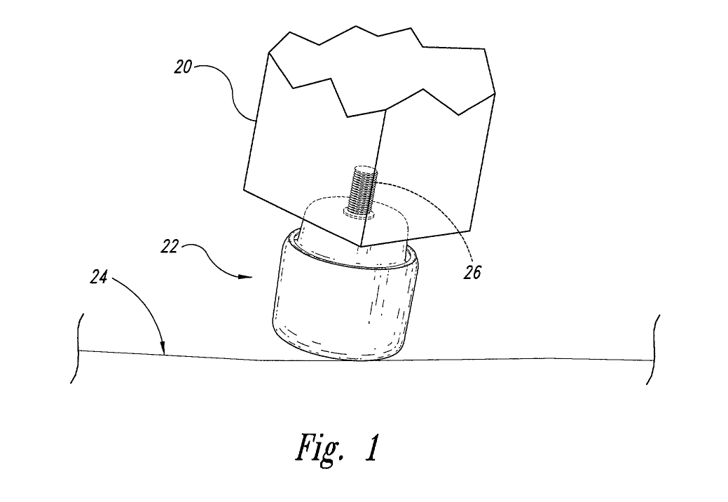

The present invention is generally directed toward furniture and foot assemblies for furniture that adjust automatically to uneven surfaces, and for methods of doing the same. Embodiments of the present invention allow an item of furniture to be placed upon uneven surfaces, and automatically stabilize the furniture to prevent it from rocking. Many specific details of certain embodiments of the invention are set forth in the following description and illustrated in FIGS. 1-15 to provide a thorough understanding of such embodiments. One skilled in the art, however, will understand that the present invention may have additional embodiments, or may be practiced without several of the details described in the following description.

FIG. 1 illustrates a portion of an item of furniture 20 supported by a foot assembly 22 on a supporting surface 24. The illustrated foot assembly 22 is attached to the item of furniture 20 by a threaded fastener 26 that engages a complementary opening (not shown) in the bottom of the item of furniture. One of ordinary skill in the art will immediately appreciate the various ways in which a foot assembly can be coupled to an item of furniture.

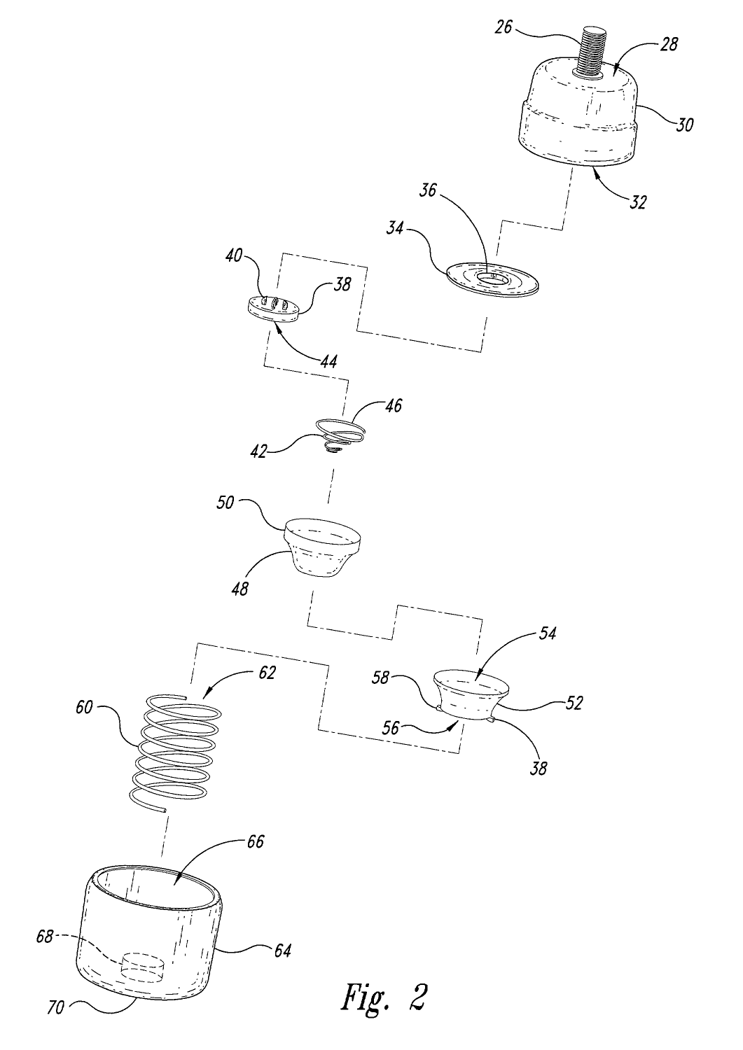

FIG. 2 is an exploded view of the foot assembly. The fastener 26 is attached to an upper surface 28 of an upper cup member 30. The upper cup member 30 is oriented such that an opening 32 of the cup faces downward during use when an upper surface 28 is adjacent the item of furniture 20. The fastener 26 can be attached to the upper cup member 30 by a wide variety of means, such as spot welding.

A washer 34 is shaped to complement the opening 32 in the upper cup member 30, and is sized to be received within the opening. The washer 34 has an aperture 36 therein that extends through the entire thickness of the washer.

A button valve 38 is configured to engage the aperture 36 from the side of the washer 34 opposite the upper cup member 30. The illustrated button valve 38 has four prongs 40 thereon that engage the aperture 36 in the washer 34, and that retain the button value 38 to the washer. As discussed in more detail below, the prongs 40 are long enough to allow the button valve 38 to move axially against and apart from the washer 34.

A conical spring 42 is positioned against an under surface 44 of the button valve 38. An uppermost coil 46 of the conical spring 42 is sized to contact the under surface 44 of the button valve 38. The uppermost coil 46 can be retained laterally against the button valve 38, such as by an elevated ridge 82 (FIG. 9) around the perimeter of the under surface 44.

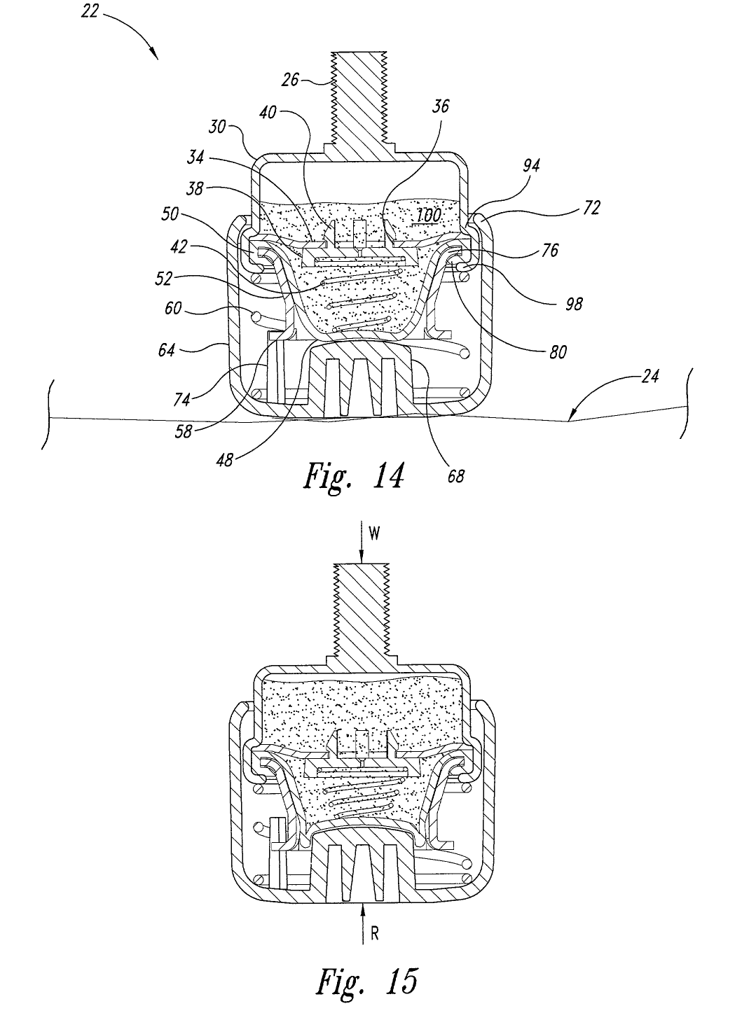

A diaphragm 48 is sized to receive the conical spring 42. An upper shoulder 50 of the diaphragm 48 is sized and shaped to be received by the opening 32 in the upper cup member 30. Accordingly, the upper shoulder 50 of the diaphragm 48 contacts the washer 34 when the two are configured for use. As illustrated in FIG. 14, the upper cup member 30 can be crimped over the washer 34 and the upper shoulder 50 of the diaphragm 48 to retain the washer, button valve 38, conical spring 42 and diaphragm in position against the upper cup member. In the illustrated embodiment, the diaphragm 48 is made from a resilient material. As a result, when crimped into the upper cup member 30, the diaphragm seals the upper cup member and the elements therebetween from the surrounding environment.

A ferrule 52 has an upper opening 54 that is sized and shaped to closely receive the lower portion of the diaphragm 48 that projects from the upper cup member 30 during use. The upper opening 54 in the ferrule 52 extends axially through the length of the ferrule, and exits through a lower opening 56. A pair of opposing tabs 58 project outwardly from the wall of the ferrule 52 surrounding the lower opening 56 in a generally radial direction with respect to the circular cross section of the ferrule.

A cylindrical spring 60 has a central opening 62 extending therethrough. The central opening 62 is sized to fit over the ferrule 52 and contact the upper cup member 30. When contacting the upper cup member 30 and fully extended, the illustrated cylindrical spring 62 is tall enough to extend from the upper cup member beyond the entire body of the ferrule 52.

A lower cup member 64 is generally hollow and has an opening 66 therein that is sized and shaped to receive all of the elements of the foot assembly therein, with the exception of the fastener 26 and, possibly, a portion of the upper cup member 30. A protuberance 68 projects upward from a bottom portion 70 of the lower cup member 64 into the hollow interior of the lower cup member. The protuberance 68 is sized and shaped to fit into the lower opening 56 and the ferrule 52.

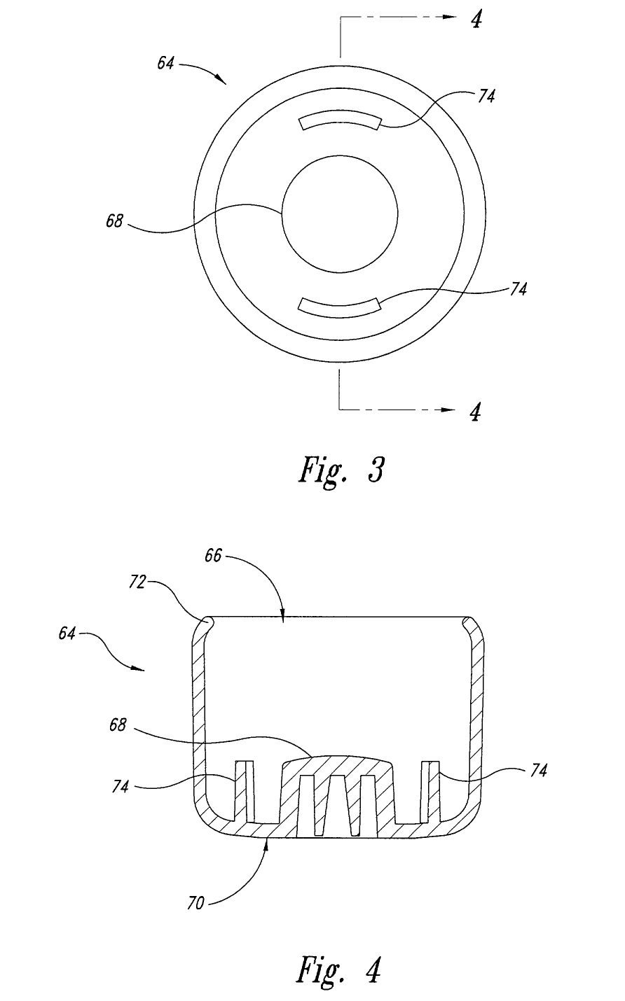

FIGS. 3 and 4 further illustrate some of the details of the lower cup member 64 of this particular embodiment of the present invention. The opening 66 is surrounded by a mouth 72 that curves inward along the perimeter of the opening. As discussed below, the mouth 72 helps to retain the lower cup member 64 to the upper cup member 30.

A pair of opposing arms 74 project upward from the bottom portion 70 of the lower cup member 64. As discussed in more detail below, the arms 74 abut against the tabs 58 on the ferrule 52 during use to allow an individual to screw the foot assembly 22 into a piece of furniture by turning the lower cup member 64.

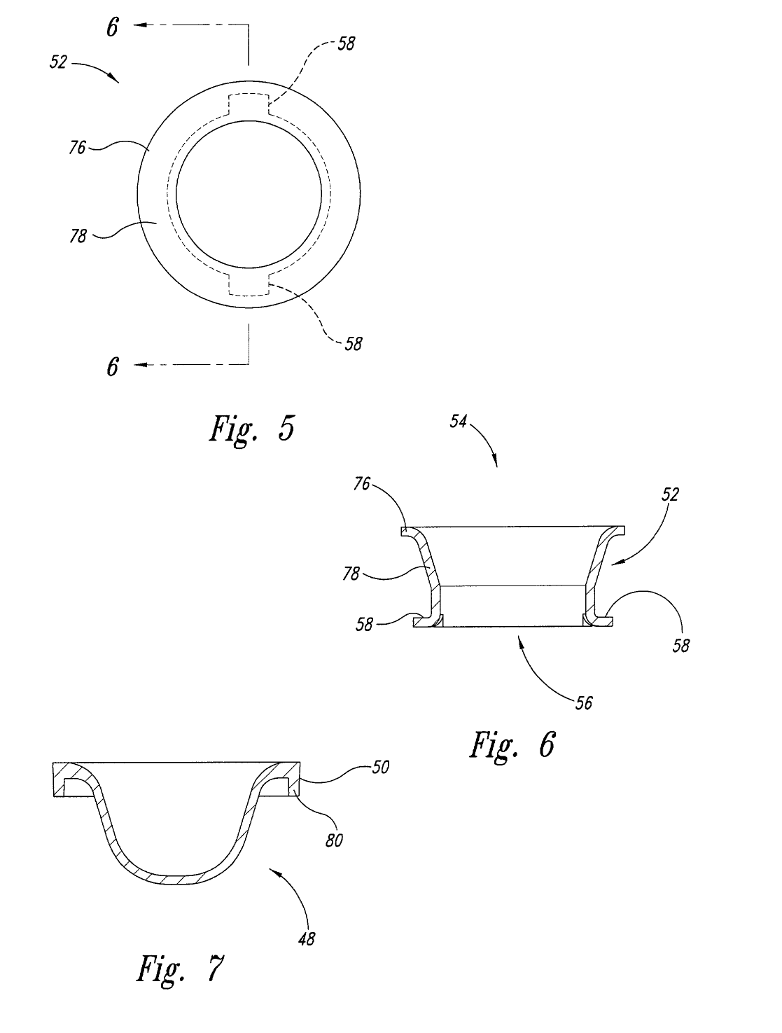

FIGS. 5 and 6 further illustrate specific details about the ferrule 52 of this particular embodiment of the present invention. The upper opening 54 of the ferrule 52 is surrounded by a lip 76 that is flared outward around the upper opening. An upper portion 78 of the ferrule 52 is tapered inward along a length of the ferrule from a widest portion adjacent with lip 76 to a narrowest portion generally central along the length of the ferrule. As described in more detail below, the lip 76 and upper portion 78 of the ferrule 52 are sized and shaped to receive the diaphragm 48, and to prevent the diaphragm from bulging outside the boundaries defined thereby during compression.

The lower opening 56 in the illustrated ferrule 52 is generally cylindrical, and is sized to allow the protuberance 68 in the lower cup member 64 to enter the ferrule 52 through the lower opening. As discussed in more detail below, the protuberance 68 will pass through the lower opening 56 to depress the diaphragm 48.

FIG. 7 further illustrates some of the details of the diaphragm 48 of this particular embodiment of the present invention. The diaphragm 48 is generally semi-spherical to complement the size and shape of the upper portion 78 of the ferrule 52, and is sufficiently resilient to conform to the same. The upper shoulder 50 of the diaphragm 48 terminates at a skirt 80 that projects downward from the upper shoulder. The skirt 80 is sized and shaped to surround the lip 76 of the ferrule 52. As discussed in more detail below, the skirt 80 will help seal the internal cavity defined by the upper cup member 30 and the diaphragm 48 from the surrounding environment.

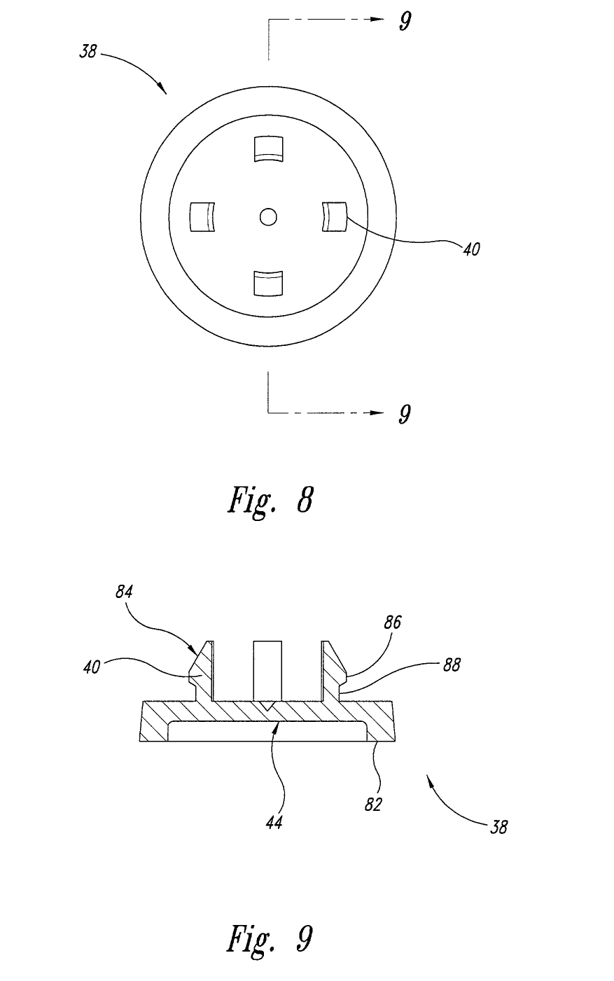

FIGS. 8 and 9 further illustrate some of the details of the button valve 38 of this particular embodiment of the present invention. The under surface 44 of the button valve 38 is surrounded by an annular ridge 82 that is sized to receive the uppermost coil 46 of the conical spring 42. The annular ridge 82 helps to retain the conical spring 42 in its operating alignment.

Each of the prongs 40 terminates at its distal end in a tapered surface 84 that is shaped to facilitate insertion of the button valve 38 into the aperture 36 of the washer 34. An enlarged head 86 resists separation of the button valve 38 from the washer 34. An elongated neck 88 separates the enlarged head 86 from the button valve 38. The neck 88 has a length that is greater than the thickness of the washer 34 to allow the button valve 38 to move actually with respect to the aperture 36.

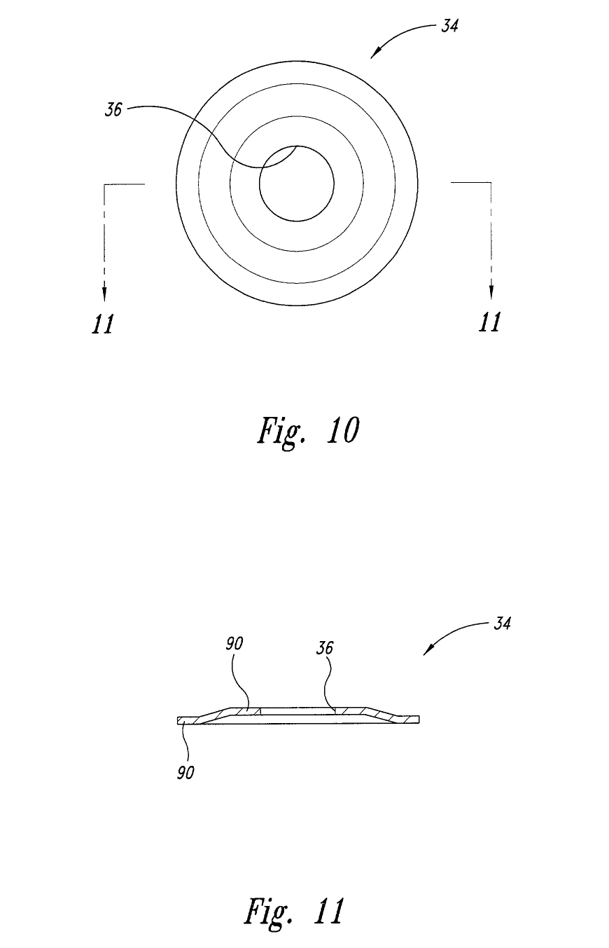

FIGS. 10 and 11 further illustrate some of the specific details of the washer 34 of this embodiment of the present invention. A central portion 90 of the illustrated washer 34 adjacent the aperture 36 is offset laterally with respect to an outer portion 92 of the washer. The shape of the washer 34 can serve to position the aperture 36 and, in turn, the button valve 38 closer to the diaphragm 48 and protuberance 68 when the foot assembly 22 is fabricated.

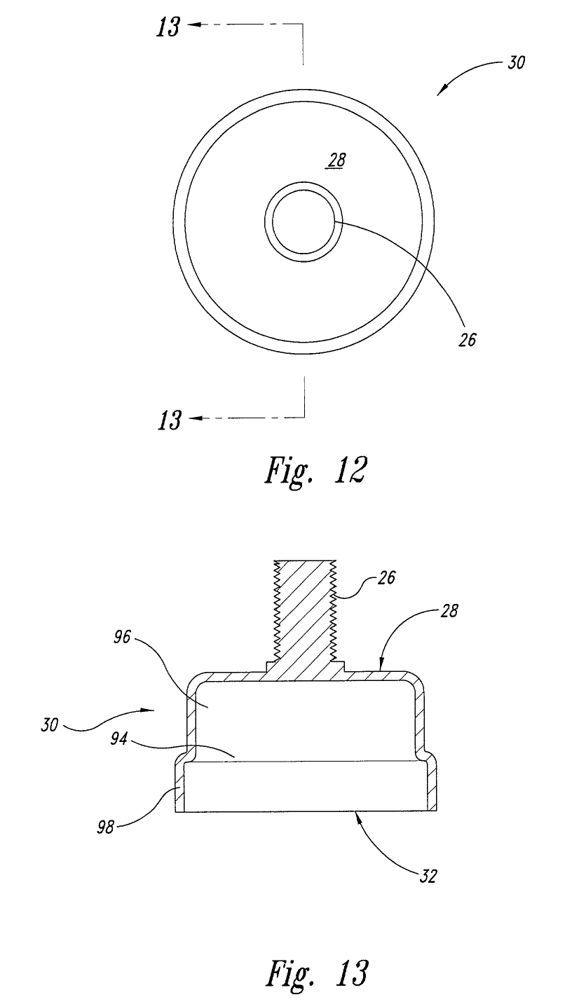

FIGS. 12 and 13 further illustrate some of the specific details of the upper cup member 30 of this particular embodiment of the present invention. An annular shelf 94 divides an upper cavity 96 from the opening 32 of the upper cup member 30. The diameter of the upper cavity 96 is thus smaller than the diameter of the opening 32. The shelf 94 is sized to prevent the washer 34 from entering the upper cavity 96. The washer 34 will instead rest along its perimeter against the shelf 94. A lower edge 98 of the upper cup member 30 is sized to receive not only the washer 34, but also the upper shoulder 50 and skirt 80 of the diaphragm 48 and the lip 76 of the ferrule 52.

FIG. 14 illustrates the foot assembly 22 after it has been completely assembled. The foot assembly 22 illustrated in FIG. 14 is fully extended, which is the configuration of the foot assembly when the item of furniture 20 is lifted off of the supporting surface 24. A volume of liquid 100 is retained within the cavity defined by the diaphragm 48 and the upper cup member 30. The volume of liquid 100 in the illustrated configuration does not fill the upper cavity 96 of the upper cup member 30. The outer portion 92 of the washer 34, the upper shoulder 50 of the diaphragm 48, and the lip 76 of the ferrule 52 are urged against the shelf 94 of the upper cup member 30. The lower edge 98 of the upper cup member 30 is crimped to retain these elements, and to seal the cavity from the surrounding environment. The skirt 80 of the diaphragm 48 is compressed between the lip 76 of the ferrule 52 and the lower edge 98 of the upper cup member 30.

The button valve 38 is engaged with the aperture 36 in the washer 34, and the conical spring 42 extends from the undersurface 44 of the button valve to the diaphragm 48. The mouth 72 of the lower cup member 64 is positioned above the shelf 94 of the upper cup member 30 to retain the lower cup member to the upper cup member. The cylindrical spring 60 urges the lower cup member 64 away from the upper cup member 30 until the mouth 72 contacts the shelf 94.

In this configuration, the foot assembly 22 can be engaged with an item of furniture 20, such as by threading the foot assembly into the item of furniture. The tabs 58 extending from the ferrule 52 are positioned to obstruct movement of the arms 74 of the lower cup member 64. As a result, when the lower cup member 64 is rotated manually by an individual, the arms 74 contact the tabs 58 to cause the entire foot assembly 22 to rotate. The individual can thus screw the foot assembly 22 into the threaded opening in an item of furniture 20.

FIG. 15 illustrates the foot assembly 22 in its compressed configuration. The foot assembly 22 might be moved into the compressed configuration after the item of furniture 20 is set onto an uneven supporting surface 24 and the weight of the item of furniture compresses the foot assembly to compensate for the uneven supporting surface.

When the item of furniture 20 is set onto a surface 24, the weight W of the item of furniture pushes downward on the upper cup member 30 and an equal resultant force R urges upward from the supporting surface on the lower cup member 64. If the weight W is greater than the restoring forces of the conical spring 42 and the cylindrical spring 60, the upper cup member 30 will move toward the lower cup member 64. As the cup members compress, the protuberance 68 deforms the diaphragm 48, forcing the liquid 100 to pass around the button valve 38 and through the aperture 36. The resistance created by the button valve 38 dampens the movement of the lower cup member 64 with respect to the upper cup member 30.

The restoring forces of the conical spring 42 and the cylindrical spring 60 can be selected such that the weight W and resultant force R are slightly greater than the restoring forces when the item of furniture 20 is in contact with the supporting surface 24. Accordingly, when the item of furniture is supported by a level surface, the foot assembly 22 will ultimately remain in or close to the compressed configuration of FIG. 15, as the weight of the table will slowly compress the foot assembly 22 until the item of furniture 20 touches plastic mouth 72 or until the foot assembly is fully compressed. However, when one or more of the foot assemblies 22 does not contact the supporting surface 24, there would be no resultant force R. As a result, those foot assemblies 22 not touching the ground would extend they contact the supporting surface 24. The foot assemblies 22 thereby allow the item of furniture 20 to be set onto an uneven supporting surface 24, and automatically adjust for the uneven support surface.

In an alternate embodiment, the restoring forces of the conical spring 42 and the cylindrical spring 60 can be selected such that the weight W and resultant force R are greater than the restoring forces only when one of the feet of the item of furniture 20 is not in contact with the supporting surface 24. Accordingly, when the item of furniture is supported by a level surface, the foot assembly 22 will remain in or close to the extended configuration of FIG. 14. However, when one of the foot assemblies 22 does not contact the supporting surface 24, the weight W would then be greater than the restoring forces of some or all of the other foot assemblies 22, as the weight would be distributed through fewer feet. As a result, those foot assemblies 22 would compress until the foot assembly that is not supported comes into contact with the supporting surface 24. The foot assemblies 22 thereby allow the item of furniture 20 to be set onto an uneven supporting surface 24, and automatically adjust for the uneven support surface.

If the item of furniture 20 is moved, the foot assemblies 22 that are lifted off of the supporting surface 24 will immediately spring back into the extended configuration. The lower cup member 64 is free to move away from the upper cup member 30 without displacing any of the liquid 100. Consequently, when the foot assembly 22 is lifted off of the supporting surface 24, the foot assembly immediately moves into the extended configuration. When the lower cup member 64 moves into the extended configuration, the force of the conical spring 42 and the resiliency of the diaphragm 48 move the diaphragm back into its extended configuration illustrated in FIG. 14, drawing the liquid 100 back into its original distribution. Because the prongs 40 allow the button valve 38 to move axially with respect to the washer 34, as the liquid 100 moves downward, the button valve also moves downward. Downward movement of the button valve 38 increases the size of the flow paths through the aperture 36, increasing the flow rate of the liquid 100. Accordingly, the rate at which the foot assembly 22 extends is significantly greater than the rate at which the foot assembly compresses.

As stated and implied above, the foot assembly of the present invention provides a number of advantages over the prior art. For example, the foot assembly not only allows an item of furniture to be set on an uneven surface, but it also allows the item of furniture to be moved with respect to that uneven surface. For example, a table on an uneven restaurant floor can be repeatedly moved between patrons without the foot assemblies needing adjustment. Likewise, when the item of furniture is moved from an uneven surface to a level surface, the foot assemblies again require no adjustment. Still further, because the liquid in the foot assembly is completely sealed from the surrounding environment, dirt, dust and other objects on the floor do not adversely affect the functioning of the foot assembly.

From the foregoing it will be appreciated that, although specific embodiments of the invention have been shown and described herein for purposes of illustration, various modifications may be made without deviating from the spirit and scope of the invention. Accordingly, the invention is not limited except as by the appended claims.

What is claimed is:

1. An item of furniture for being supported on a surface during use, the item of furniture comprising:
a body;
at least one first foot member coupled to a lower portion of the body;
a second foot member slidably coupled to the first foot member for reciprocal movement with respect to the first foot member along a reciprocating axis oriented to intersect the surface during use;
a biasing member urging the second foot member apart from the first foot member along the reciprocating axis; and
a dampening member coupled between the first and second foot members, the dampening member containing liquid that flows through a restricted opening as the second foot member moves toward the first foot member to dampen relative acceleration of the second member toward the first member.

2. The item of claim 1 wherein:
the dampener comprises a diaphragm, a dividing member and a volume of liquid, the diaphragm being sealably coupled to the first foot member, the dividing member being positioned between the diaphragm and the first foot member to define a first cavity between the dividing member and the diaphragm and second cavity between the dividing member and the first foot member, the dividing member having an aperture therein, at least a portion of the fluid being positioned within the first cavity; and
the second foot member is configured to deform the diaphragm toward the dividing member when the second foot member moves toward the first foot member;
such that movement of the second foot member toward the first foot member forces a displaced portion of the fluid from the first cavity, through the aperture and into the second cavity, dampening the movement of the second foot member toward the first foot member, and such that movement of the second foot member away from the first foot member allows the diaphragm to move away from the dividing member, drawing at least a portion of the displaced portion of the fluid from the second cavity, through the aperture and into the first cavity.

3. The item of claim 2 further comprising a second biasing member positioned between the dividing member and the diaphragm to urge the diaphragm apart from the dividing member when the second foot member moves apart from the first foot member.

4. The item of claim 2 further comprising a valving member engaged with the aperture, the valving member being movable between an open position in which a flow of the fluid is relatively unrestricted between the first and second cavities, and a closed position in which the flow is restricted but not prevented, the valving member moving to the closed position as a result of increased pressure in the first cavity such that movement of the second foot member toward the first foot member moves the valving member into the closed position, dampening the movement of the second foot member toward the first foot member.

5. The item of claim 2 further comprising a valving member and a second biasing member, the second biasing member being positioned between the dividing member and the diaphragm to urge the diaphragm apart from the dividing member, the valving member being engaged with the aperture and movable between an open position in which a flow of the fluid is relatively unrestricted between the first and second cavities, and a closed position in which the flow is restricted but not prevented, the valving member moving to the closed position when the second foot member moves more than a minimum distance toward the first foot member, dampening the movement of the second foot member toward the first foot member.

6. The item of claim 1 wherein the dampening member resists relative acceleration of the second member toward the first member, but does not resist relative acceleration of the second member apart from the first member.

7. A foot assembly for an item of furniture to compensate for an uneven surface, the foot assembly comprising:
a first foot member configured to be coupled to the item of furniture;
a second foot member slidably coupled to the first foot member for reciprocal movement with respect to the first foot member along a reciprocating axis oriented to intersect the surface during use;
a biasing member urging the second foot member apart from the first foot member along the reciprocating axis; and
a dampening member coupled between the first and second foot members, the dampening member containing liquid that flows through a restricted opening as the second foot member moves toward the first foot member to dampen relative acceleration of the second member toward the first member.

8. The foot assembly of claim 7 wherein:
the dampener comprises a diaphragm, a dividing member and a volume of liquid, the diaphragm being sealably coupled to the first foot member, the dividing member being positioned between the diaphragm and the first foot member to define a first cavity between the dividing member and the diaphragm and second cavity between the dividing member and the first foot member, the dividing member having an aperture therein, at least a portion of the fluid being positioned within the first cavity; and
the second foot member is configured to contact the diaphragm when the second foot member moves toward the first foot member;
such that movement of the second foot member toward the first foot member forces a displaced portion of the fluid from the first cavity, through the aperture and into the second cavity, dampening the movement of the second foot member toward the first foot member, and such that movement of the second foot member away from the first foot member allows the diaphragm to move away from the dividing member, drawing at least a portion of the displaced portion of the fluid from the second cavity, through the aperture and into the first cavity.

9. The foot assembly of claim 8 further comprising a second biasing member positioned between the dividing member and the diaphragm to urge the diaphragm apart from the dividing member when the second foot member moves apart from the first foot member.

10. The foot assembly of claim 8 further comprising a valving member engaged with the aperture, the valving member being movable between an open position in which a flow of the fluid is relatively unrestricted between the first and second cavities, and a closed position in which the flow is restricted but not prevented, the valving member moving to the closed position as a result of increased pressure in the first cavity such that movement of the second foot member toward the first foot member moves the valving member into the closed position, dampening the movement of the second foot member toward the first foot member.

11. The foot assembly of claim 8 further comprising a valving member and a second biasing member, the second biasing member being positioned between the dividing member and the diaphragm to urge the diaphragm apart from the dividing member, the valving member being engaged with the aperture and movable between an open position in which a flow of the fluid is relatively unrestricted between the first and second cavities, and a closed position in which the flow is restricted but not prevented, the valving member moving to the closed position when the second foot member moves more than a minimum distance toward the first foot member, dampening the movement of the second foot member toward the first foot member.

12. The foot assembly of furniture of claim 7 wherein the dampening member resists relative acceleration of the second member toward the first member, but does not resist relative acceleration of the second member apart from the first member.

13. A foot assembly for an item of furniture to compensate for an uneven surface, the foot assembly comprising:
a first foot member configured to be coupled to the item of furniture;
a second foot member slidably coupled to the first foot member for reciprocal movement with respect to the first foot member along a reciprocating axis oriented to intersect the surface during use;
a biasing member urging the second foot member apart from the first foot member along the reciprocating axis; and
a two-chambered cavity interposed between the first and second foot members, an opening between the chambers being configured to allow a fluid to pass therebetween at a desired rate, the cavity being coupled between the first and second foot members such that the fluid is forced through the opening from one chamber to the other as the second foot member moves toward the first foot member to dampen relative acceleration of the second member toward the first member.

14. The assembly of claim 13 wherein the second foot member comprises a contact member configured for resting against the surface during use.

15. The assembly of claim 13 wherein one of the two chambers of the cavity is fabricated from a resilient material such that the fluid is forced from one chamber to the other due to deformation of the resilient material.

16. The assembly of claim 13, further comprising a valving member between the two chambers of the cavity.

17. The assembly of claim 13, further comprising a valving member between the two chambers of the cavity, the valving member being movable between an open position in which a flow of the fluid between the two chambers is relatively unrestricted, and a closed position in which the flow is significantly restricted to dampen the movement of the second foot member with respect to the first foot member.

18. The assembly of claim 13, further comprising a valving member between the two chambers of the cavity, the valving member being movable between an open position in which a flow of the fluid between the two chambers is relatively unrestricted, and a closed position in which the flow is significantly restricted to dampen the movement of the second foot member with respect to the first foot member.

19. A method for supporting an item of furniture having a plurality of legs on an uneven surface, the method comprising:
coupling a first foot member to each of the legs;
slidably engaging a second foot member with each of the first foot members;
positioning a dual-chamber cavity between the first and second foot members, the dual-chamber cavity being at least partially filled with a fluid and configured such that movement of the second foot member toward the first foot member forces fluid through an aperture between the two chambers, thus resisting relative acceleration of the second foot member toward the first foot member;
lifting the item of furniture above the uneven surface and urging each of the second foot members away from the respective first foot members; and
resting the item of furniture on the uneven surface such that at least three of the legs are supported by the uneven surface, and allowing at least one of the corresponding second foot members to move toward the first foot member under the force of gravity until the remaining legs are supported by the uneven surface.
